(19) United States
(12) Patent Application Publication
(10) Pub. No.: US 2026/0181504 A1
(43) Pub. Date: Jun. 25, 2026

(54) CONDITIONAL DUAL ACTIVE PROTOCOL STACK (DAPS) FOR RECOVERY FROM RADIO LINK FAILURE (RLF) BASED ON RLF PREDICTIONS

(71) Applicant: InterDigital Patent Holdings, Inc., Wilmington, DE (US)

(72) Inventors: Oumer Teyeb, Montreal (CA); Brian Martin, Farnham (GB); Yugeswar Deenoo Narayanan Thangaraj, Chalfont, PA (US); Dylan Watts, Montreal (CA)

(73) Assignee: InterDigital Patent Holdings, Inc., Wilmington, DE (US)

(21) Appl. No.: 18/990,181

(22) Filed: Dec. 20, 2024

(51) Int. Cl. H04W 36/18; H04W 36/00; H04W 36/30; H04W 36/36; H04W 76/30

(52) U.S. Cl. CPC H04W 36/185; H04W 36/008355; H04W 36/305; H04W 36/362; H04W 76/30

(57) ABSTRACT

A wireless transmit/receive unit (WTRU) comprises a processor configured to send capability information related to radio link failure (RLF) prediction. The capability information may be based on an artificial intelligence (AI)/machine learning (ML) model. The processor may receive configuration information associated with radio link monitoring (RLM) and RLF detection and prediction, receive second configuration information associated with a dual active protocol stack (DAPS) handover configuration to one or more candidate cells, predict RLF of a serving cell at a predicted RLF time, determine a target cell, initiate a DAPS handover with the target cell using the DAPS configuration corresponding with the target cell and while maintaining a connection with the serving cell, detect a RLF of the serving cell at the predicted RLF time or within a time window that includes the predicted RFL time, and finalize the DAPS handover to the target cell.

### BACKGROUND

A wireless transmit/receive unit (WTRU) may use an artificial intelligence (AI)/machine learning (ML) model to predict a radio link failure (RLF) before it actually happens and may take a recovery action based on that. This recovery action could be a re-establishment and/or the execution of a conditional handover (CHO)/L1/L2 triggered mobility (LTM) to a candidate cell (e.g., if the best cell at the time of the RLF prediction has an associated CHO/LTM configuration).

Performing pre-emptive recovery based on RLF prediction, especially re-establishment, may be costly if the prediction was not correct. For example, if the prediction was wrong and the radio link with the source recovers, the re-establishment or CHO/LTM executed based prediction (and any associated connection interruption) would have been in vain, and the WTRU may be handed over back to the source cell where the RLF was predicted soon after the recovery. In some examples, how to use RLF predictions to ensure HO without interruption if/when RLF happens may be implemented.

### SUMMARY

A wireless transmit/receive unit (WTRU) may comprise a processor. The processor may be configured to send capability information related to radio link failure (RLF) prediction. The capability information may be based on an artificial intelligence (AI)/machine learning (ML) model. The processor may be configured to receive configuration information associated with radio link monitoring (RLM) and RLF detection and prediction. The processor may be configured to receive second configuration information associated with a dual active protocol stack (DAPS) handover configuration to one or more candidate cells. The processor may be configured to predict RLF of a serving cell of the WTRU at a predicted RLF time. The processor may be configured to determine a target cell from the one or more candidate cells. The processor may be configured to initiate a DAPS handover with the target cell using the DAPS configuration corresponding with the target cell and while maintaining a connection with the serving cell. The processor may be configured to detect a RLF of the serving cell at the predicted RLF time or within a time window that includes the predicted RFL time. The processor may be configured to finalize the DAPS handover to the target cell.

The DAPS handover configuration may include, for example, a condition to initiate a DAPS handover. The processor may be configured to initiate the DAPS handover upon a determination that the condition to initiate the DAPS handover has been satisfied.

The condition to initiate the DAPS handover may include, for example, a predicted RLF time and a signal level threshold. The processor may be configured to initiate the DAPS handover with the target cell upon a prediction that the WTRU will experience a RLF with the serving cell within the predicted RLF time and a signal level of the target cell is above the signal level threshold.

The processor may be configured to determine the target cell based on the target cell having a strongest signal level of the one or more candidate cells that have a respective signal level above the signal level threshold.

The DAPS configuration may include, for example, a condition to finalize the DAPS handover. The processor may be configured to finalize the DAPS handover upon a determination that the condition to finalize the DAPS handover has been satisfied.

The condition to finalize the DAPS handover upon the determination that the WTRU has experienced RLF with the serving cell at the predicted RLF time or within the time window that may include the predicted RLF time.

The processor may be configured to release the connection with the serving cell and send an indication to the network that the DAPS handover has been finalized and the connection with the serving cell was released.

The DAPS configuration may include, for example, a condition to cancel the DAPS handover. The processor may be configured to cancel the DAPS handover to the target cell upon a determination that the condition to cancel the DAPS handover has been satisfied.

The condition to cancel the DAPS handover upon the determination that the WTRU has not experienced RLF with the serving cell at the predicted RLF time or within the time window that may include the predicted RLF time.

The processor may be configured to release the connection with the target cell. The processor may be configured to send an indication to the network that indicates that the DAPS handover has been canceled and the connection with the target cell was released.

The processor may be configured to determine that RLF of the serving cell did not occur at the predicted RLF time or within the time window that includes the predicted RFL time. The processor may be configured to release the DAPS configuration with the target cell. The processor may be configured to send an indication to the network that indicates that the DAPS configuration with the target cell was released.

A WTRU may be configured to perform a method that includes one or more of the following steps. The method may include sending capability information related to radio link failure (RLF) prediction. The capability information may be based on an artificial intelligence (AI)/machine learning (ML) model. The method may include receiving configuration information associated with radio link monitoring (RLM) and RLF detection and prediction. The method may include receiving second configuration information associated with a dual active protocol stack (DAPS) handover configuration to one or more candidate cells. The method may include predicting RLF of a serving cell of the WTRU at a predicted RLF time. The method may include determining a target cell from the one or more candidate cells. The method may include initiating a DAPS handover with the target cell using the DAPS configuration corresponding with the target cell and while maintaining a connection with the serving cell. The method may include detecting a RLF of the serving cell at the predicted RLF time or within a time window that includes the predicted RFL time. The method may include finalizing the DAPS handover to the target cell.

The DAPS handover configuration may include, for example, a condition to initiate a DAPS handover. The method may include initiating the DAPS handover upon a determination that the condition to initiate the DAPS handover has been satisfied.

The condition to initiate the DAPS handover may include, for example, a predicted RLF time and a signal level threshold. The method may include initiating the DAPS handover with the target cell upon a prediction that the WTRU will experience a RLF with the serving cell within the predicted RLF time and a signal level of the target cell is above the signal level threshold.

The method may include determining the target cell based on the target cell having a strongest signal level of the one or more candidate cells that have a respective signal level above the signal level threshold.

The DAPS configuration may include, for example, a condition to finalize the DAPS handover. The method may include finalizing the DAPS handover upon a determination that the condition to finalize the DAPS handover has been satisfied.

The condition to finalize the DAPS handover upon the determination that the WTRU has experienced RLF with the serving cell at the predicted RLF time or within the time window that may include the predicted RLF time.

The method may include releasing the connection with the serving cell and send an indication to the network that the DAPS handover has been finalized and the connection with the serving cell was released.

The DAPS configuration may include, for example, a condition to cancel the DAPS handover. The method may include cancelling the DAPS handover to the target cell upon a determination that the condition to cancel the DAPS handover has been satisfied.

The condition to cancel the DAPS handover upon the determination that the WTRU has not experienced RLF with the serving cell at the predicted RLF time or within the time window that may include the predicted RLF time.

The method may include releasing the connection with the target cell. The method may include sending an indication to the network that indicates that the DAPS handover has been canceled and the connection with the target cell was released.

The method may include determining that RLF of the serving cell did not occur at the predicted RLF time or within the time window that includes the predicted RFL time. The method may include releasing the DAPS configuration with the target cell. The method may include sending an indication to the network that indicates that the DAPS configuration with the target cell was released.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating an example radio link monitoring (RLM) and radio link failure (RLF) detection and/or recovery procedure according to an embodiment.

FIG. 3 is a system diagram illustrating an example dual active protocol stack (DAPS) handover (HO) procedure according to an embodiment.

FIG. 4 is a flowchart illustrating an example procedure for performing conditional DAPS for recovery from RLF according to an embodiment.

### DETAILED DESCRIPTION

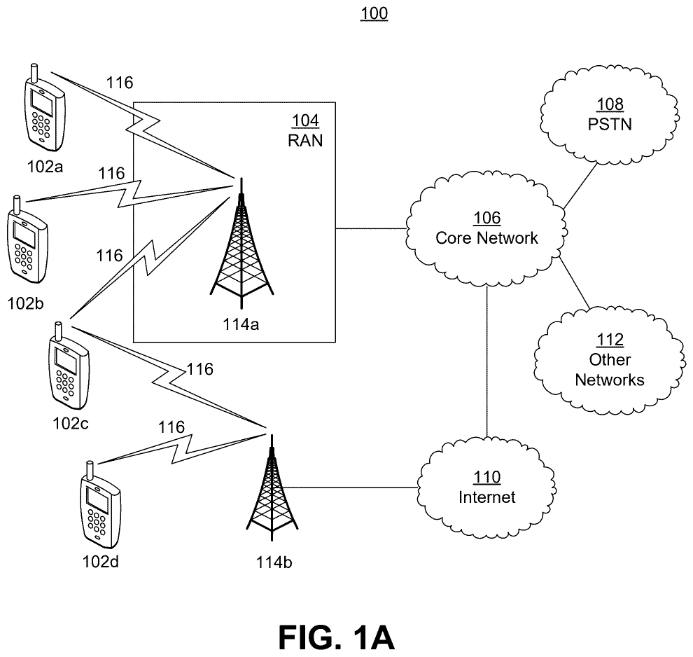

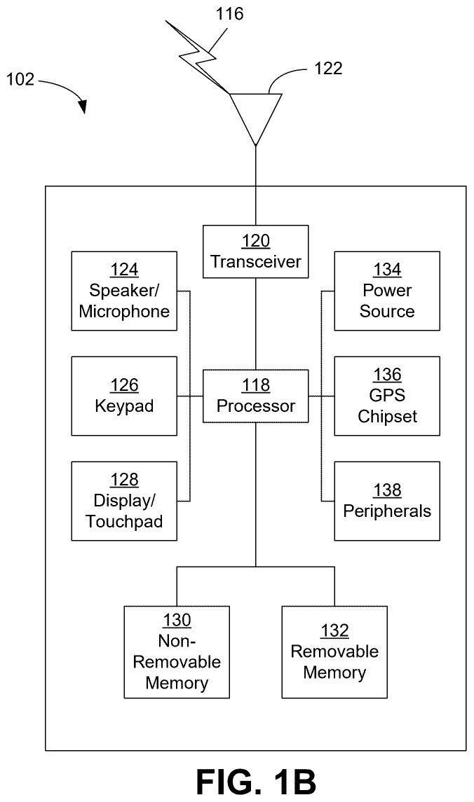

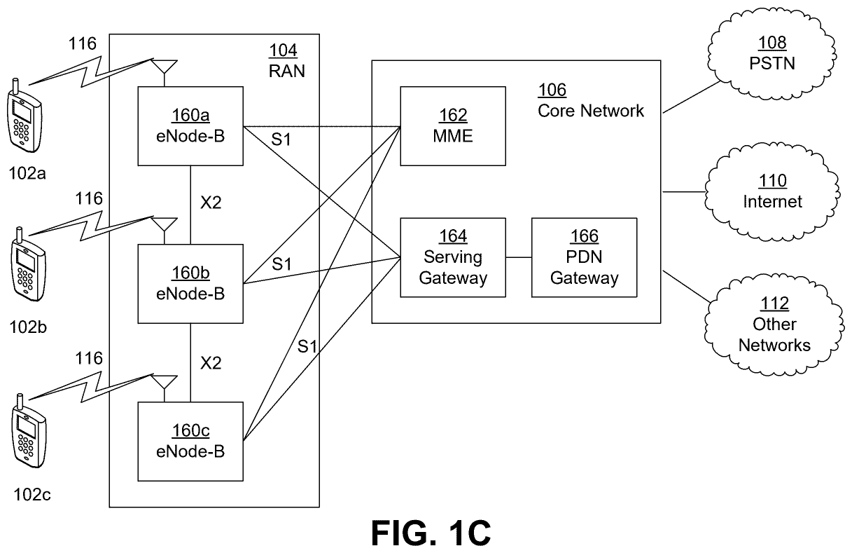

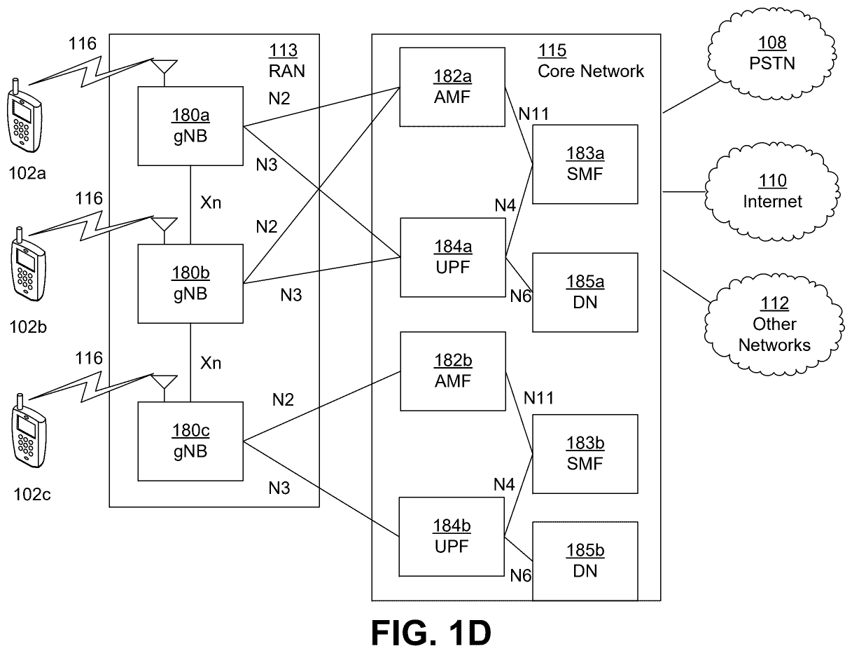

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may be configured to conditionally initiate a dual active protocol stack (DAPS) handover to a target cell based on radio link failure (RLF) predictions and radio conditions of the target cell. A WTRU may be configured to conditionally finalize the DAPS handover to a target cell and release the source connection and/or context if and/or when the RLF is detected (e.g., within a given time window from the predicted RLF time). A WTRU may be configured to conditionally cancel the DAPS handover and revert to the connection only with the source upon determination that the RLF didn't happen as predicted or is not more expected and/or predicted to happen.

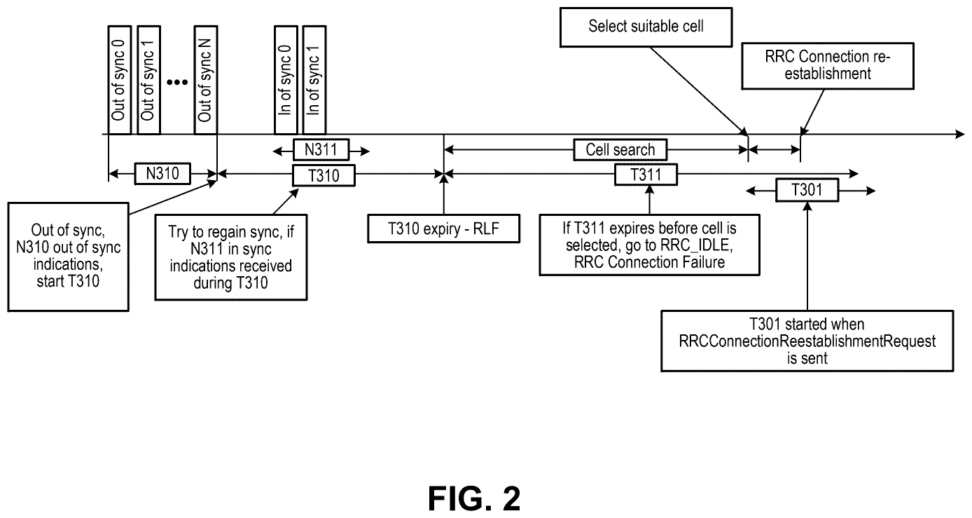

Radio link monitoring and radio link failure may be implemented. While in RRC_CONNECTED state, the WTRU may perform Radio Link Monitoring (RLM) on the serving cell (e.g., the primary cell in the case of multiple cells configured for carrier aggregation). The WTRU may be configured with timers and counters to use when detecting Radio Link Failure (RLF) and performing radio link recovery and/or re-establishment. The physical layer (PHY) sends out of sync (OOS) and in sync (IS) indications to the radio resource control (RRC), based on whether the serving cell's signal-to-interference plus noise ratio (SINR) is below or above a configured SINR threshold. For example, as shown in FIG. 2, upon the detection of N310 consecutive OOS indications from PHY, the RRC starts a timer with a duration of T310. While T310 is running, the WTRU attempts to recover the radio link on the serving cell. If N311 consecutive IS indications are received at RRC from PHY, then the timer is stopped, and the WTRU considers the radio link to have been recovered and resumes normal operation and continues RLM on the serving cell. If T310 expires before the N311 consecutive IS indications are received, then the WTRU considers this as an RLF. Upon detection of RLF, a timer is started with the duration of T311, and the WTRU performs a cell search in order to determine whether there is a suitable cell available on which the WTRU may perform RRC connection re-establishment. If the timer T311 expires before the WTRU finds a suitable cell, then the WTRU enters RRC_IDLE mode with the cause “RRC Connection failure”. If the WTRU does find a suitable cell (e.g., which could be the original serving cell), then this suitable cell is selected, T311 is stopped, T301 is started, and an RRC Connection re-establishment procedure is started. If the timer T301 expires before the RRC Connection re-establishment is complete, then the WTRU enters idle mode with the cause “RRC Connection failure”.

A RLF may occur, for example, when the WTRU goes out of coverage (e.g. entering a tunnel and/or moving to a rural area out of cellular coverage). An RLF may occur, for example, as a result of too late of a handover, whereby RLF is detected on the serving cell before a handover can be completed. The first part of the procedure (N310, T310, N311) is intended to allow the WTRU a chance to recover the radio link in case of a temporary problem. The second part of the procedure after T310 expiry is intended to allow the WTRU to attempt to re-establish the connection on the same or another cell without having to release the connection completely. See FIG. 2 which summarizes an example of RLM and RLF detection procedures.

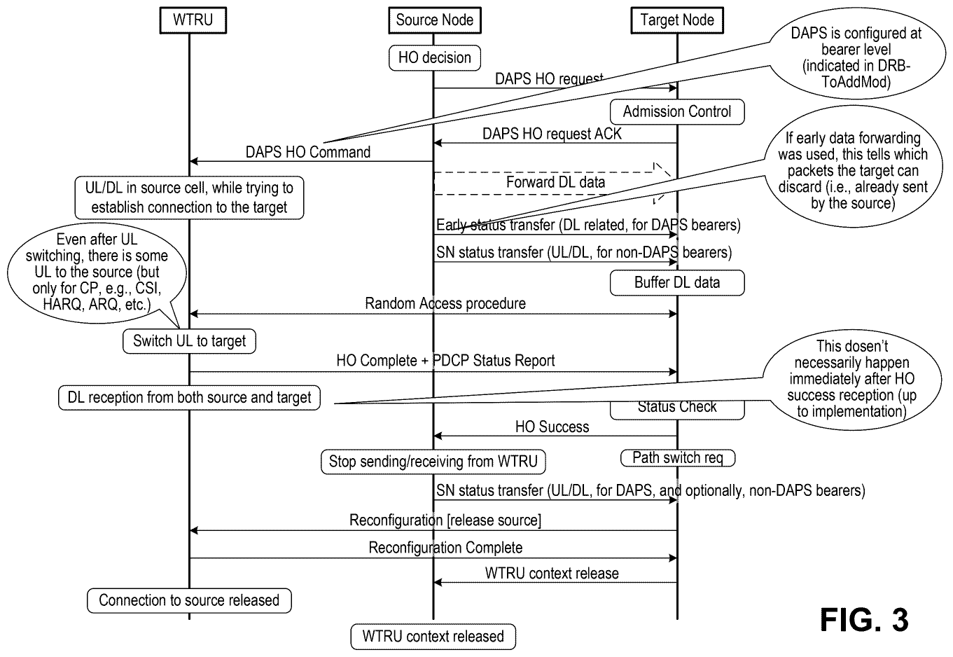

Dual active protocol stack (DAPS) may be implemented. The concept of DAPS handover (HO) was introduced for both LTE and NR in order to reduce the interruption time during handover which, for example, could range from 30 ms (milliseconds) to 60 ms in LTE, depending on the handover scenario, thereby ensuring that the quality of highly delay sensitive services will not be degraded because of mobility. The DAPS HO procedure is illustrated in the FIG. 3.

The source node, upon deciding to perform a DAPS HO, may send a DAPS HO request to the target node. A DAPS HO request may be a handover request that includes information regarding to which data radio bearers (DRBs) the DAPS HO is to be applied (e.g., it is possible that for some DRBs normal HO can be applied). After performing admission control, the target responds with a HO request acknowledgement.

The source may send a DAPS HO command to the WTRU, which is an radio resource control (RRC) reconfiguration with reconfigurationWithSync that also contains an indication regarding which DRBs are to be involved in DAPS HO. The source may continue normal operation for uplink (UL) data (e.g. forwarding it to the core network) and for downlink (DL) (e.g. sending it to the WTRU), but also starts forwarding the DL data towards the target.

Once the WTRU has managed to perform random access (RA) with the target, UL data transmission may be switched to the target, but DL reception is still performed from the source. The WTRU may send a HO complete, which is an RRC reconfiguration complete message, to the target, including the packet data convergence protocol (PDCP) status report for those DRBs that were configured for DAPS HO. The target may start sending the buffered DL data to the WTRU, using the status information provided by the WTRU to avoid the sending of duplicate packets (e.g. packets forwarded from the source but now indicated to have been received by the WTRU).

The target may indicate the success of the handover to the source, after which the source stops sending and/or receiving data to and/or from the WTRU. The target may initiate a path switch towards the core, so that new DL data will be sent to the target node instead of the source. The target may indicate to the WTRU the DAPS HO is finalized by sending an RRC reconfiguration message that contains a daps-SourceRelease indicator, upon which the WTRU may release the connection to the source. The target may send a context release message to the source, so that all the WTRU context at the source gets released.

DAPS handover may be configured on a DRB level (e.g. normal PDCP/radio link control (RLC)/MAC procedures applied for the bearers not configured for DAPS handover) and a handover may be referred to as a DAPS handover if at least one bearer is configured for DAPS. The handover mechanism triggered by RRC may require the WTRU at least to reset the MAC entity and re-establish RLC, except for DAPS handover, where upon reception of the handover command, the WTRU may do the following. For example, upon reception of the handover command, the WTRU may create a MAC entity for the target. Upon reception of the handover command, the WTRU may establish the RLC entity and an associated logical channel for the target for each DRB configured with DAPS (e.g., hence the name dual protocol stack). For the DRB configured with DAPS, upon reception of the handover command, the WTRU may reconfigure the PDCP entity with separate security and robust header compression (ROHC) functions for source and target and may associate them with the RLC entities configured by the source and the target. Upon reception of the handover command, the WTRU may retain the rest of the source configurations until instructed to release the source.

Since the mobile terminal may receive user data simultaneously from both the source and target cell, the PDCP layer may be reconfigured to a common PDCP entity for the source and target user plane protocol stacks. To secure in-sequence delivery of user data, PDCP Sequence Number (SN) continuation is maintained throughout the handover procedure. For that reason, a common (e.g., for source and target) re-ordering and duplication function is provided in the single PDCP entity. Ciphering and/or deciphering and header compression and/or decompression are handled separately in the common PDCP entity, depending on the origin and/or destination of the DL/UL packet.

Artificial Intelligence and Machine Learning (AI/ML) for NR may be implemented. A study item on AI/ML mobility enhancements has been executed, with the main objective of studying enhancements for network triggered L3-based handover (e.g., handover triggered by the network based on information received by the WTRU, such as measurement reports). In some examples, enhancements based on RLF and handover failure (HOF) predictions are also being studied.

In some examples, methods for performing a conditional DAPS handover, where the DAPS HO is initiated based on RLF prediction, finalized if RLF gets detected and/or released if RLF prediction was wrong, may be implemented. In some examples, a WTRU may send capability information related to radio link failure detection (e.g., based on an AI/ML model).

A WTRU may receive a configuration of radio link monitoring and/or radio link failure detection and prediction parameters (e.g., based on the capability the WTRU has indicated), where the configuration may include conditional DAPS-like configuration to one or more candidate cells, where the conditional DAPS configuration may include one or more of the following. For example, the conditional DAPS configuration may include conditions to initiate the DAPS handover (e.g., T310 expected to start within a given time, RLF predicted within a given time, T310 has started and predicted to expire before recovery, radio signal level of candidate cell above a certain threshold, etc.). The conditional DAPS configuration may include conditions to finalize the DAPS handover (e.g., RLF detected, etc.). The conditional DAPS configuration may include conditions to cancel the DAPS handover (e.g., RLF didn't happen as predict, T310 stopped due to recovery of source radio link, etc.).

In some examples, a WTRU may perform the radio link monitoring and radio link failure detection and prediction. In some examples, upon determining that conditions to initiate the DAPS handover are fulfilled (e.g., RLF predicted at t+Δt, and there is a candidate cell that has the required signal level), the WTRU may determine the target cell for DAPS (e.g. the DAPS candidate cell with the strongest signal level, based on current measurements and/or predicted measurement at t+Δt). The WTRU may execute the DAPS-like configuration associated with the target cell. The WTRU may start receiving DL data from the target cell. The WTRU may maintain UL with the source.

In some examples, upon detecting an RLF at the predicted RLF time (e.g. or within a configured time window of the predicted time), the WTRU may finalize the DAPS HO (e.g., like legacy behavior after reception of release source configuration message from the target during DAPS HO).

In some examples, upon determining that RLF didn't occur (e.g., the prediction was wrong), and/or predicting that RLF is no more expected to occur at the predicted time (e.g., within a given time window of the predicted RLF time), the WTRU may release the DAPS configuration and release resources/configuration of the target (e.g., UL/DL communication only with the source). In some examples, the WTRU may send an indication to the network about the release of the DAPS.

By initiating an early DAPS to a target cell based on RLF prediction, the WTRU may be enabled to be handed over to a target cell without interruption if the RLF happens as predicted, otherwise, the DAPS is reverted, ensuring unnecessary HO is not performed.

Artificial intelligence (AI) may be broadly defined as the behavior exhibited by machines. Such behavior may, for example, mimic cognitive functions to sense, reason, adapt and act. Machine learning (ML) may refer to type of algorithms that solve a problem based on learning through experience (‘data’), without explicitly being programmed (‘configuring set of rules’). Machine learning can be considered as a subset of AI. Different machine learning paradigms may be envisioned based on the nature of data or feedback available to the learning algorithm. For example, a supervised learning approach may involve learning a function that maps input to an output based on labeled training example, wherein each training example may be a pair consisting of input and the corresponding output. For example, unsupervised learning approach may involve detecting patterns in the data with no pre-existing labels. For example, reinforcement learning approach may involve performing sequence of actions in an environment to maximize the cumulative reward. In some solutions, it is possible to apply machine learning algorithms using a combination or interpolation of the above-mentioned approaches. For example, semi-supervised learning approach may use a combination of a small amount of labeled data with a large amount of unlabeled data during training. In this regard semi-supervised learning falls between unsupervised learning (with no labeled training data) and supervised learning (with only labeled training data).

Deep learning (DL) refers to class of machine learning algorithms that employ artificial neural networks (specifically DNNs) which were loosely inspired from biological systems. The Deep Neural Networks (DNNs) are a special class of machine learning models inspired by human brain wherein the input is linearly transformed and pass-through non-linear activation function multiple times. DNNs typically consists of multiple layers where each layer consists of linear transformation and a given non-linear activation functions. The DNNs can be trained using the training data via back-propagation algorithm. Recently, DNNs have shown state-of-the-art performance in variety of domains, for example, speech, vision, natural language etc. and for various machine learning settings supervised, un-supervised, and semi-supervised. The term AI/ML based methods and/or processing may refer to realization of behaviors and/or conformance to requirements by learning based on data, without explicit configuration of sequence of steps of actions. Such methods may enable learning complex behaviors which might be difficult to specify and/or implement when using legacy methods.

A given AI/ML model may be trained under certain WTRU and network side additional conditions. For example, a WTRU side condition could be the speed of the WTRU. On the other hand, network side additional conditions may be something that may be related to some network configurations and/or settings that the WTRU may not be aware of but may impact the performance of the model. For example, an RLF prediction model may perform differently if it is trained when the network was using a certain antenna pattern, beam pattern, power levels, and so on. Also, there could be aspects related to network load, that may have impact on the model performance.

Since the WTRU doesn't necessarily need to know all the details of the network side additional conditions, and network may also not want to expose some of these implementations, the network may hide these details by signaling to the WTRU one or more associated ID(s). For example, when data is being collected for training a model, tagging may be performed indicating under which network side additional conditions the model is being trained. When a WTRU is being configured to perform the AI/ML based RLF prediction, it may be configured to check the consistency between the conditions under which the AI/ML model is trained on and/or current conditions (e.g., current WTRU conditions, current associated ID(s) signaled by the network indicating current network conditions/settings, etc.).

In some examples discussed herein, it may be assumed that the WTRU will be performing the AI/ML based RLF prediction only if it has an AI/ML model that is applicable to the current WTRU and network side additional conditions. For example, the network may have communicated the current associated ID(s), and the WTRU has indicated that it has a model that is capable of working under the current WTRU conditions and associated ID(s), and based on that the network has activated the AI/ML functionality at the WTRU. In case the applicability changes while the functionality is being used, the WTRU may be configured to stop the AI/ML functionality and start using legacy procedures (e.g., WTRU informing change of applicability to the network and network deactivating the functionality, WTRU autonomously deactivating the functionality when it determines applicability has changed, etc.). The applicability change may be due to the change in WTRU side conditions such as speed changes and the WTRU has no model trained for those conditions, and/or the associated ID changes and WTRU has no model trained for the new associated ID, where the associated ID change could be due to the WTRU performing a HO to a cell that is operating under different network conditions, and/or the network changing some of its configurations without the WTRU performing a HO, etc.

The term Life cycle management (LCM) is used to describe the overall management aspects of AI/ML models, such as model training, functionality/model identification, model delivery/transfer, and/or model inference operation. LCM may include functionality/model selection, activation, deactivation, switching, and fallback operation. Functionality/model selection, activation, deactivation, switching, and fallback operation may include decisions by the network (e.g., either network initiated or WTRU-initiated and requested to the network), and/or decisions by the WTRU (e.g., event-triggered as configured by the network, WTRU's decision reported to the network, or WTRU-autonomous either with WTRU's decision reported to the network or without it). LCM may include functionality/model monitoring, model update, WTRU capability, and/or data collection (e.g., for model training, for monitoring, for inference, etc.).

In some examples, LCM can be functionality-based LCM or model-ID based LCM. In functionality-based LCM, the network indicates activation/deactivation/fallback/switching of AI/ML functionality via signaling (e.g., RRC, MAC-CE, downlink control information (DCI)). Models may not be identified at the network, and the WTRU may perform model-level LCM. The WTRU may have one AI/ML model for the functionality, and/or the WTRU may have multiple AI/ML models for the functionality. In model-ID-based LCM, models are identified at the network, and network and/or WTRU may activate/deactivate/select/switch individual AI/ML models via model ID.

In the functionality based LCM, the WTRU may choose the AI/ML model to use for a certain functionality (e.g., network decides for which functionalities the WTRU can use AI/ML based operation, and the WTRU chooses the AI/ML model to use). In the model-ID based LCM, the network may explicitly control which particular model is used for a given AI/ML functionality. For example, the WTRU provides details of AI/ML models and their capabilities, network determines which model to activate for a particular functionality.

In some examples, the discussed methods may be applicable to both model-ID based and functionality-based LCM. The solutions may be related to how the WTRU determines whether it has a model that is applicable for the indicated associated ID(s). For example, in the case of functionality-based LCM, the WTRU may be configured and/or requested to determine if a given functionality is valid and/or applicable, and it may do the determination among all the models it has for a given functionality and may consider the functionality applicable if at least one of the models is applicable. In another example, in the case of model-ID based LCM, the WTRU may be configured and/or requested by the network to determine whether a particular model is applicable or not.

The WTRU may support several AI/ML models for a given functionality (e.g., with different prediction time horizons, prediction confidence levels, processing requirements, trained under/for operation in different frequencies/cells/location/times of day, etc.). A given AI/ML model for a certain functionality may operate in different modes (e.g., with different levels of prediction confidence levels at different prediction time horizons, at different locations, frequencies, WTRU mobility pattern/speed, etc.). The AI/ML models can be available at the WTRU already trained, and/or the WTRU may be provided with an untrained AI/ML model and performs the training by itself. The AI/ML model may be available at the WTRU already trained, and the WTRU may be enabled and/or configured to perform further training (e.g., for different conditions such as frequencies/cells/location/times of day, for the same conditions as the initial training but for increasing the level of confidence or/and the prediction time horizon, for different WTRU speeds, etc.). The AI/ML model may be available at the WTRU but not trained at all or only trained for certain WTRU and/or network conditions, and WTRU may be configured to train the model (e.g. for the conditions that it is not trained for).

In some examples, the WTRU may require some configurations and/or inputs that it needs for performing the inference using an AI/ML model. For example, for RLF prediction, the WTRU may need to be configured with a certain number of beams and/or cells to measure to determine the prediction. In some cases, the WTRU may communicate the required configuration and/or input as part of the capability information. In some examples, the required configuration and/or input may be communicated to the network after capability request (e.g., based on explicit network request, if the WTRU gets configured to do AI/ML based RLF predictions, and it has determined that it is lacking the required configuration/input, etc.).

All the examples described herein are agnostic to the kind of AI/ML model and/or technique used by the WTRU (e.g., the algorithm used, the mechanism such as neural network or what kind of neural network, e.g., depth and parameters/weights of the network, etc.), the origins of the model (e.g., WTRU vendor, operator, network vendor, etc.), or how and/or where the training of the model is done (e.g., the input data used for the training, where the training is performed, if the training is performed offline or online, etc.). However, it can be assumed that the model is trained based on historical observation of one or more WTRUs' actual measurements in different WTRU and network conditions (e.g., during certain time durations of the day, during certain days of the week, at different locations, different WTRU mobility patterns/speeds, under different network conditions that are visible to the WTRU such as frequency/bandwidth, etc., under different network configurations, which may be visible to the WTRU just as a network configuration index that is provided by the network at the time of training or data collection for the training, etc.).

The terms AI/ML and AIML may be used interchangeably. The terms “data”, “measurements”, “report” and “results” may be used interchangeably. The terms indication, information and message may be used interchangeably. The terms “current cell”, “serving cell”, and “source cell” may be used interchangeably. The terms “target cell” and “candidate cell” may be used interchangeably. The terms “handover” and “cell switching” may be used interchangeably. The terms functionality and procedure may be used interchangeably. The terms “execute”, “apply” and “perform” may be used interchangeably. The terms “trigger” and “initiate” may be used interchangeably. The terms legacy and non-AI/ML may be used interchangeably.

Though the focus of the example descriptions below and herein are on prediction based on AI/ML models, the example methods are equally applicable to any other form of prediction that doesn't use AI/ML (e.g. time series forecasting, interpolation methods, etc.).

WTRU capability and related aspects may be implemented. In some examples, the WTRU may send its RLF prediction related capability to the network (e.g., based on explicit request from the network, proactively by the WTRU, etc.). The capability, for example, may indicate the supported AI/ML models and/or functions by the WTRU, confidence level of predictions, time horizon of predictions (e.g., how far along in the future are the prediction being made), and/or other conditions under which the functions and/or models work (e.g., network side additional conditions, WTRU side additional conditions, time of day, locations, for example, cells/global navigation satellite systems (GNSS) co-ordinates, etc.).

In one solution, the WTRU may send its capability related to mobility (e.g., DAPS, etc.) to the network (e.g., based on explicit request from the network, proactively by the WTRU, etc.). The capability, for example, could indicate if the WTRU supports DAPS, if the WTRU supports dual UL operation during DAPS (which is currently not supported by the standards), whether the WTRU supports DAPS at different frequencies (e.g., the frequency of the source and target cell), and if so, the frequencies the WTRU supports (e.g., in a set of frequency pairs, etc.).

In some examples, the WTRU may perform an indirect RLF prediction, wherein the AI/ML model may first predict a time series of SINR values of the serving cell in the future, and this may be used on the legacy RLF detection procedure (e.g., in FIG. 2 the occurrence of N310 consecutive out of syncs and then the expiry of the T310 before N311 consecutive in-syncs), to derive the expected time of an RLF.

In some examples, the WTRU may perform a direct RLF prediction, wherein the AI/ML model may provide a prediction of the probability of an RLF happening within a time window in the future (e.g., without the need to do the intermediate prediction of the SINR).

In some examples, if the WTRU supports indirect RLF prediction, the WTRU may further indicate to the network further capability regarding the margin of window for the predicted RLF prediction (e.g., as it will be very unlikely that the predicted RLF will occur exactly at a given time, even if the model is very accurate). For example, the WTRU may indicate a margin of error window length and/or duration of +/−X milliseconds (ms). That means, when the WTRU predicts an RLF to occur at time t1, the WTRU expects the RLF to occur between t1−X and t1+X. Alternatively and/or additionally, the WTRU may expect a different margin for the lower and upper window (e.g., RLF predicted to occur at t1 indicates that the RLF is expected to occur between t1−X1 and t1+X2).

In some examples, the WTRU may indicate to the network whether it supports direct RLF prediction, indirect RLF prediction and/or both. In some examples, if the WTRU supports both direct and indirect RLF prediction, the WTRU may be left to WTRU implementation to decide which RLF prediction and corresponding model to apply. In some examples, the network may configure the WTRU to perform the prediction using direct or indirect prediction models.

Configurations and behavior related to the RLF prediction may be implemented. As described above, herein and in FIG. 2, the RLF detection procedure consists of two phases, phase 1 and phase 2. Phase 1 consists of detection of radio link problem (e.g., N310 consecutive OOSs). Phase 2 consists of detection if recovery happens or doesn't happen within T310 after radio link problem was detected in phase 1 (e.g., no N311 consecutive OOSs are observed during the T310). In some examples, the WTRU may have a model that is concerned about only phase 1. For example, the WTRU may have a model that will predict when T310 timer is expected to start (e.g., with more than a given confidence level). In some examples, the WTRU may have a model that is concerned about only phase 2. For example, the WTRU may have a model that can be used after T310 has started (e.g., the N310 consecutive OOSs have already been detected) to predict whether the T310 will expire before the required N311 consecutive ISs are detected. In some examples, the WTRU may have a model that is concerned about both phase 1 and phase 2. For example, the WTRU may have a model that can be used to predict both the start time of the T310 and whether there will be recovery or not after that.

The WTRU may have different models for predicting phase 1 and phase 2. This may be applicable for both direct and indirect prediction. In some examples, the WTRU may be configured to predict the occurrence of a certain number of consecutive OOSs (e.g., n1, where n1=N310, n1<N310, n1>N310, etc.) and consider phase 1 is predicted when the configured number of OOSs have been predicted to occur (e.g., within a given time from the current time, with a confidence level above a certain configured threshold).

In some examples, the WTRU may be configured to consider phase 1 is predicted when a certain number consecutive OOSs (e.g., n1) have already been detected and a certain number of consecutive OOSs (e.g., n2) are predicted to occur (e.g., within a given time from the current time, with a confidence level above a certain configured threshold). For example, n1 and n2 may be configured as independent numbers and/or relative to each other. For example, the WTRU may be configured with the total of the two (e.g., n1+n2) and may determine the phase 1 is predicted when the number of actual detected consecutive OOSs and the predicted ones is equal to n1+n2 (e.g., actual=n3, predicted=(n1+2)−n3, where n3 is any number between 0 and n1+n2).

In some examples, the WTRU may be configured to predict the occurrence of a certain number of consecutive ISs (e.g., n1, where n1=N311, n1<N311, n1> N311, etc.) after T310 has started and consider recovery is predicted (e.g., no RLF predicted) if it predicts that n1 consecutive ISs are predicted to occur (e.g., before the T310 expiry, for example, within a certain confidence level), or otherwise consider there will be an RLF.

In some examples, the WTRU may be configured to consider recovery is predicted when a certain number consecutive ISs (e.g., n1) have already been detected after T310 has started and a certain number of consecutive ISs (e.g., n2) are predicted to occur (e.g., before the T310 expiry, with a confidence level above a certain configured threshold). For example, n1 and n2 can be configured as independent numbers or relative to each other. For example, the WTRU may be configured with the total of the two (e.g., n1+n2) and may predict that RLF will not be detected (e.g. recovery during phase 2) when the number of actual detected consecutive ISs and the predicted ones is equal to n1+n2, before the T310 expiry (e.g., actual=n3, predicted=(n1+n2)−n3, where n3 is any number between 0 and n1+n2).

In some examples, the WTRU may be configured to do the prediction of RLF or not RLF without splitting it into phase 1 and phase 2 considerations. For example, the WTRU may be configured with n1 (e.g., related to N310) and n2 (e.g., related to N311) and T310, and may directly predict if the RLF is expected to occur at a certain time in the future (e.g., delta_T from the current time).

The configuration of the parameters described above and herein may be dependent on confidence levels. For example, the WTRU may be configured with a multitude of n1 and n2 parameters that were discussed above for the OOSs and ISs (e.g., n1_1, n1_2, n1_3, etc., each associated with different confidence levels of the prediction). For example, the WTRU may be configured to consider phase 1 detection if n1_1 OOSs are predicted to occur with a confidence level c1, n1_2 OOSs are predicted to occur with a confidence level between c1 and c2, and so on.

Instead of considering consecutive OOSs and ISs, the WTRU may be configured to consider a total number of OOSs and ISs for the RLF prediction. For example, the WTRU may be configured to consider that phase 1 will be detected if n1_1 consecutive OOSs are predicted or if n1_2 OOSs (e.g., consecutive or not) are predicted to occur within a given time (e.g., 10 consecutive OSSs and/or 15 not-necessarily consecutive OSSs within a given configured duration). The WTRU may be configured to consider the radio link to be recovered if n2_1 consecutive ISs are predicted before T310 expiry or if n2_2 ISs (e.g., consecutive or not) are predicted before the T310 expiry (e.g., 10 consecutive ISs, or 15 not necessarily consecutive ISs before T310 expiry).

WTRU reporting of RLF predictions may be implemented. In some examples, the WTRU may be configured to report information related to an RLF prediction (e.g., indication that RLF is expected to occur at a given time from now or within a given time window). In some examples, the WTRU may be configured to send a report regarding phase 1 (e.g., an indication that the T310 is expected to start a given time or a time window). In some examples, the WTRU may be configured to send a report regarding phase 2 (e.g., an indication that the T310 is expected to expire before recovery of the source link).

In some examples, the WTRU may be configured to send additional information in the RLF prediction. For example, the additional information may be time related information (e.g., time or time window when the RLF is expected to occur, or where T310 is expected to start, etc.). Additionally and/or alternatively, the time information may be an implicit information (e.g., the WTRU may have already indicated the time horizon or lead time and/or window of the prediction in the WTRU capability). For example, the additional information may be confidence level information of the prediction. Additionally and/or alternatively, the confidence level may be implicit information (e.g., the WTRU may have already indicated the confidence level of the prediction in the WTRU capability). In one example, the additional information may be related to measurements of current and neighbor cells. The measurements may be detailed measurements (e.g., RSRP/RSRQ, etc.) of these cells, and/or just an order and/or list of the strongest cells (e.g., the top n cells, where n is configured by the network).

For example, the measurement information may be based on current measurements. In The measurement information may be based on predicted measurements (e.g., at the time where the RLF is predicted to happen). The measurement information may be based on both current and predicted measurements (e.g., include both current and predicted measurements of the neighbor cell, include the top n cells based on predicted measurements, and/or include the top n cells based on the average of the current and predicted measurements, etc.).

In some examples, the WTRU may receive, in response to the RLF report indication it has according to any of the solutions above, a message from the network that may include a DAPS configuration to one or more target cell as described in detail below and herein.

In some examples, the WTRU may already have received a DAPS related configuration for one or more target cells, before it has sent the RLF prediction report, but it may have been further configured to not activate and/or execute them (e.g., “conditional DAPS”) and the response message from the network to the prediction report may be an indication to activate and/or initiate one or more of these DAPS configuration.

In some examples, the WTRU may not receive any response from the network after sending an RLF prediction report (e.g., all the configuration information related to DAPS operation for RLF recovery may have been received by the WTRU before the sending of the RLF prediction report).

In some examples, the WTRU may have received some of the configuration information related to DAPS before sending the RLF prediction report, and it may receive the remaining information after the sending of the RLF prediction. For example, the WTRU may have received the legacy DAPS configuration beforehand but did not activate it, and after the sending of the RLF prediction report, the network may configure the WTRU with other information related to starting/finalizing/reverting the DAPS (e.g., radio thresholds, as described in detail below and herein) depending on if and/or when the RLF gets detected or not.

Initiating DAPS conditionally may be implemented. In legacy DAPS, the WTRU is given a HO command that indicates this is a DAPS HO (e.g., with an indication which of the radio bearers are configured for DAPS for dual DL reception while the DAPS is ongoing). The WTRU immediately executes the DAPS HO (e.g., as in legacy HO), switches UL communication towards the target after successful random access (RA) with the target and will receive the DL for the DAPS bearers from both the source and the target while receiving the DL data for the non-DAPS bearers only from the target.

In some examples, the WTRU may be configured with a conditional DAPS configuration, where the DAPS HO may not be immediately executed and/or initiated upon reception of the configuration, and instead the WTRU may be provided with one or more conditions for triggering the initiation of the DAPS HO. In some examples, the condition for initiating the DAPS HO towards a target may be the prediction of an RLF by the WTRU. In some examples, the condition for initiating the DAPS HO towards a target cell may be that the WTRU has made a prediction about phase 1 with a confidence level above a given confidence level threshold (e.g., if the WTRU predicts that N310 consecutive OOSs will be detected at time t1 from now with a confidence level of above the threshold, regardless of the time t1). In some examples, the condition for initiating the DAPS HO towards a target cell is that the WTRU has made the prediction about phase 1 and the time for the expected start of T310 is below a certain configured time duration threshold. In some examples, the condition for initiating the DAPS HO towards a target cell may be that the WTRU has made the prediction about phase 1 with a confidence level above a given confidence level threshold and the time for the expected start of T310 is below a certain configured time duration threshold.

In some examples, the WTRU may be configured to initiate the DAPS HO towards a target cell a certain configured time duration before the expected and/or predicted time of the RLF. The WTRU may be configured to initiate the DAPS HO within a given time window, where the time window length is dependent on the prediction. For example, if the WTRU was using an indirect prediction that gives a prediction time of occurrence for the RLF and some error margin window (e.g., +/−Xms), the WTRU may be configured to initiate the DAPS HO no earlier than the t1−X and no later than t1+X, where t1 is the predicted time for the RLF. In another example, if the WTRU is using a direct RLF prediction model (e.g., RLF expected to occur between t1 and t2), then the WTRU may be configured to initiate the DAPS HO towards the target no earlier than t1 and no later than t2.

In some examples, the WTRU may consider an even shorter window for the initiation of the DAPS HO as compared to the predicted RLF window. In the example of direct prediction (e.g., RLF predicted between t1 and t2), the WTRU may be configured to initiate the DAPS HO between t3 and t4, where t1<=t3<=t4<=t2. The values of t3 and t4 may be explicit and/or they may be relative to the values of t1 and t2 and/or the difference between the two. For example, if the difference between t1 and t2 was 600 ms, the WTRU may be configured to initiate the DAPS HO at some point in time between t1+150 ms and t1+450 ms (e.g., the inner half of the time window of the prediction).

In some examples, the WTRU may be configured to initiate the DAPS HO towards a target cell only if that cell has a signal level above a certain configured threshold. The WTRU may be configured to initiate the DAPS HO towards a target cell only if that cell has a signal level stronger than the current cell by more than a certain configured threshold. The WTRU may be configured to initiate the DAPS HO towards a target cell only if the signal level of the current cell is not better than the target cell by more than a certain configured threshold. The WTRU may be configured to initiate the DAPS HO towards a target cell only if the signal level of the strongest neighbor cell is not better than the target cell by more than a certain configured threshold.

In some examples, the WTRU may consider not only current measurements but also predicted measurement of the serving and/or neighbor cell for determining whether the DAPS HO towards a target cell should be initiated. For example, the WTRU may be configured to determine to initiate the DAPS HO to a target cell if the radio conditions of the target cell are expected to fulfill certain conditions (e.g., absolute or relative thresholds, as discussed above and herein) at the time when RLF is expected (e.g., the target cell may not be fulfilling the conditions at the moment, but expected to fulfill the conditions at the time when RLF is predicted). Consideration of the current and/or expected radio signal levels may also be configured (e.g., WTRU configured with absolute and/or relative thresholds for current measurements and with additional absolute and/or relative thresholds for predicted measurement at the time of RLF prediction).

In some examples, the WTRU may be provided with more than one conditional DAPS configuration and/or targets. In some examples, if the WTRU is provided with more than one conditional DAPS target and/or more than one of them fulfill the DAPS initiation criteria (e.g., according to one or more of the solutions above), the WTRU may be configured to choose the target cell amongst these DAPS target cells with the strongest signal level and initiate the DAPS HO towards it.

In some examples, if more than one of the targets fulfill the DAPS HO initiation criteria based on the current radio conditions, the WTRU may be configured to consider also predicted radio measurements (e.g., at predicted RLF time) to choose the target to initiate the DAPS HO to (e.g., the target that still fulfills the radio conditions, for example, above a certain configured threshold, when RLF happens, the target that is expected to have the best radio conditions when RLF happens, etc.)

In some examples, the WTRU, upon initiating the DAPS HO to a target according to any of the solutions above, may still keep the UL configuration and/or context with the source (e.g., in case the DAPS HO is to be cancelled as described below and herein and the WTRU has to revert the connection back to the source). For example, this includes information such as the TA with the source, scheduling request (SR) configuration, and so on that will be need for UL communication with the source (as described below and herein).

Finalizing DAPS conditionally may be implemented. In legacy DAPS, the WTRU may finalize the DAPS (e.g., release all the resource and/or context associated with the source cell and completely switches to the target (e.g., all UL/DL reception will be with the target only) when the WTRU receive an explicit RRC message from the target that indicates to the WTRU to release the source. Once the WTRU has initiated the DAPS HO (e.g., after it has performed successful RA towards the target), the UL communication for all bearers will be only with the target. However, until the time the source is released, DL reception for the DAPS bearers may be from both source and target while DL reception for non-DAPS bearers may be only from the target. As described herein, the releasing of the source configuration and switching completely to the target is referred to as “finalization of the DAPS HO”.

In some examples, the WTRU may be configured to finalize the DAPS HO to a target cell that it has initiated according to any of the solutions above when the RLF with the source cell get detected (e.g., not just predicted, e.g., T310 expires). The WTRU may be configured to finalize the DAPS HO at the time when the RLF was predicted even if the RLF is not detected yet. The WTRU may be configured to finalize the DAPS HO at the time when the RLF was predicted even if RLF has not been detected yet, if the WTRU is still having problem with the current serving cell (e.g., T310 is running, it is not in sync yet with the source cell, a certain number of OOSs have been detected since T310 has started, a certain number and/or percentage of the RLM indications from the PHY have been OSSs within a certain configured time duration before the predicted RLF time, etc.). The WTRU may be configured to finalize the DAPS HO to a target cell if that target fulfills certain radio conditions (e.g., at the predicted RLF time, even if RLF has not been detected yet). This radio condition could be an absolute threshold (e.g., better than a threshold) and/or a relative threshold (e.g., not worse than the strongest neighbor cell at that time by more than a certain threshold, better than the current cell by more than a certain threshold, etc.).

The WTRU may be configured to consider not only current measurements but also predicted measurement of the target cell. For example, the WTRU may be configured to finalize the DAPS HO to a target if the target's signal level is expected to be above a certain configured threshold (e.g., or not worse than the strongest serving cell by more than a certain configured threshold, but better than the current cell by more than a certain threshold, etc.) for a given time duration in the future. The WTRU may be configured to finalize the DAPS if a certain configured time duration has elapsed since the DAPS HO was initiated (e.g. this can be further constrained by any of radio signal level based thresholds discussed above, for example, the configured time duration has elapsed and target cell has a signal level better than the source cell by more than a certain threshold, etc.)

In some examples, the WTRU, upon finalizing the DAPS HO to a target according to any of the examples above and herein, may release all the resources and/or context associated with the source cell (e.g., the same behavior as a legacy WTRU upon the reception of an RRC message to release the source at the end of a DAPS HO). The WTRU, upon finalizing the DAPS HO to a target according to any of the solutions above and herein, may send an indication to the network (e.g., target), indicating that it has released the source connection. In this indication, the WTRU may be configured to include additional information (e.g., a cause value indicating that source was released due to actual RLF detection, a cause value indicating that the source was released even though RLF was not detected but the radio conditions of the target were fulfilling certain conditions, as described in any of the solutions above and herein, etc.). The additional information may also indicate some information related to the RLF prediction and/or actual RLF detection (e.g., time difference between the predicted time and actual RLF time, etc.).

In some examples, the indication of the finalization of the DAPS HO may be sent to the target. The indication of the finalization of the DAPS HO may be sent to the source (e.g., if the finalization was done even without actual RLF detection according to any of the solutions above and herein, and the WTRU still has an UL connection with the source, and/or has maintained some UL information with the source such as the TA and SR configuration, using which it may send a scheduling request for a grant to send the indication of the DAPS finalization).

Canceling DAPS conditionally may be implemented. In legacy DAPS HO, there may be no cancelation. That is, the WTRU sooner or later may be configured to release the source and switch completely to the target. For the scenario discussed herein, however, there may be a need to cancel the DAPS HO and switch back to the source, as the DAPS could have been initiated based on predictions of a radio link problem with the source cell, and those predictions may have been wrong.

In some examples, the WTRU may detect that the RLF prediction was wrong based on one or more of the following. For example, the WTRU may detect that the RLF prediction was wrong based on the link with the source recovered before T310 has started (e.g., if prediction was made before T310 has started, if the DASP HO was triggered based only on phase 1 prediction as discussed above, etc.). The WTRU may detect that the RLF prediction was wrong based on T310 gets stopped (e.g., DAPS HO may have been triggered before or after T310 has started according to any of the solutions above, but T310 was started but then stopped due to the WTRU getting back in sync with the source). The WTRU may detect that the RLF prediction was wrong based on the WTRU making a new RLF prediction and that is indicating that RLF is not expected to occur as predicted before (e.g., no RLF predicted for a long duration, and/or RLF predicted but it is at a time duration farther away from the previous prediction, etc.). The WTRU may detect that the RLF prediction was wrong based on the predicted RLF time and/or window has elapsed, but RLF has not been detected or T310 has not started, etc.

In some examples, when the WTRU has determined that the RLF prediction was wrong, it may be configured to cancel an ongoing DAPS HO. In some examples, the WTRU may cancel an ongoing DAPS HO if a certain configured time duration has elapsed since the DAPS HO was initiated but RLF has not been detected with the source yet.

In some examples, the WTRU may cancel an ongoing DAPS HO depending on the source and/or target radio conditions, in addition to the determination that the RLF prediction was wrong. For example, the WTRU may determine to cancel the DAPS HO to a target if an RLF has not been detected as predicted and that the radio conditions of the target are below a certain absolute or relative threshold (e.g., relative to the source cell, relative to the strongest neighbor cell, etc.). the WTRU may determining to cancel the DAPS HO to a target may be considering just current radio conditions and/or predicted radio conditions (e.g., different thresholds for current conditions and future and/or predictions radio conditions, where the future and/or predictions may be regarding a certain configured time duration).

When canceling a DAPS HO, the WTRU may release the resources and/or context associated with the target. In some examples, the WTRU may send an indication to the network that the DAPS HO has been cancelled. In some examples, the cancelation indication may be sent to the source. The cancelation indication may be sent to the target (e.g., just before the target resources and/or context is released).

Other aspects and generalizations may be implemented. In legacy DAPS, the UL may be completely switched to the target after the success of RA to the target, and this may not cause any issue as there will be no cancelation.

The DAPS HO may be cancelled as discussed above and herein. To enable this, in one example, the WTRU may be configured to maintain at least some of the UL resources and/or configuration of the source cell even after RA with the target was completed. Maintaining at least some of the UL resources and/or configuration of the source cell may include configurations such as the TA, scheduling request resources, and so on. For example, the WTRU, upon determining to do the DAPS cancelation, may send an indication to the source (e.g., the WTRU may need to send an SR to the source to get an UL grant to send this indication).

In some examples, the WTRU may send the indication of the cancellation to the target and then the target may communicate with the source regarding the cancellation. The WTRU may then immediately start monitoring the physical downlink control channel (PDCCH) of the source to get any UL grant (e.g., DCI format 0) that it may then start using for sending subsequent UL data via the source. In some examples, the WTRU may send a SR to the source to get an UL grant for sending subsequent UL data via the source.

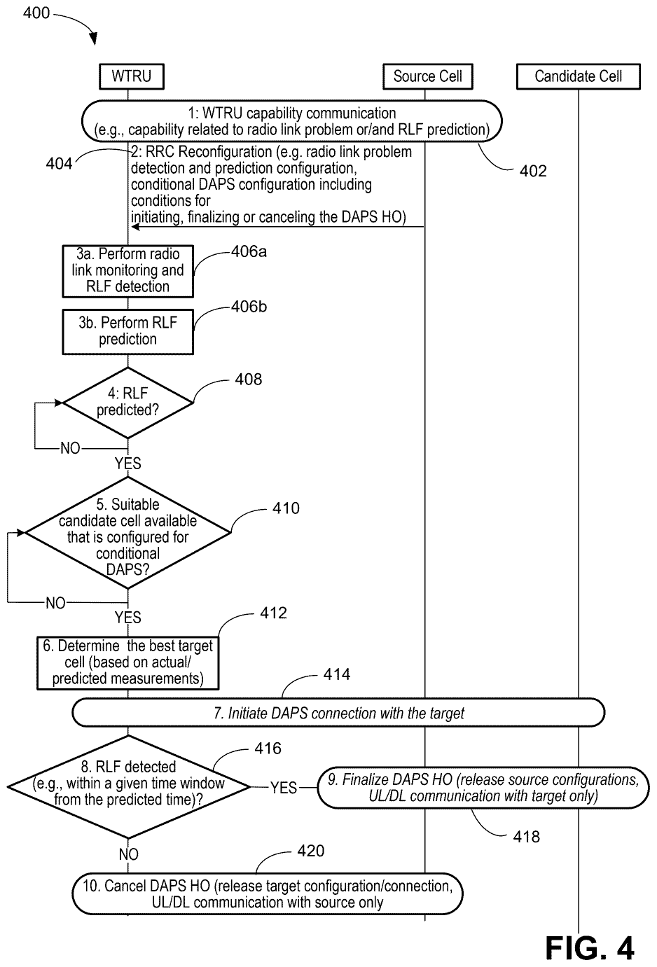

FIG. 4 is an example of a procedure 400 for Conditional DAPS for recovery from RLF. The procedure 400 may be performed by a WTRU. The procedure 400 may start at 402. At 402, the WTRU may inform the network about capabilities related to radio link problem and/or radio link recovery and/or radio link failure prediction, as well as capability related to DAPS support. At 504, the WTRU may receive a configuration regarding a radio link problem or a RLF prediction. The configuration may contain one or more of the following. For example, the configuration may contain parameters related to radio link problem determination and prediction (e.g., N310 counter values, lead time, confidence levels, etc.). The configuration may contain DAPS HO related information (e.g., DAPS target cells and corresponding DAPS configuration, absolute and/or relative thresholds for determining when a DAPS can be initiated, and/or absolute and/or relative thresholds for determining when a DAPS can be finalized or cancelled, etc.). At 406a, the WTRU may perform RLM monitoring and/or detection of RLF (e.g., as in legacy). At 406b, the WTRU may perform the prediction of radio link problem and/or RLF according to the received parameters. At 408, the WTRU may predict that an RLF is going to occur. At 410, the WTRU may determine that that there is at least on target cell configured for DAPS that fulfills the DAPS initiation radio conditions. At 412, if there were multiple cells configured for DAPS and they satisfy the DAPS initiation conditions, the WTRU may select the strongest cell among them. At 414, the WTRU may initiate the DAPS HO and may initiate DAPS connection with the target. At 416, the WTRU may detect RLF at the predicted time (e.g., or within a given window of the predicted RLF time). At 418, if the WTRU detects RLF at step 416, the target may fulfill the DAPS finalization radio conditions, and finalizes the DAPS HO (e.g., release the source context/resources/configuration and/or communicate only with the target). At 420, if the WTRU doesn't detect RLF as expected (e.g., or within a given window of the predicted RLF time) at step 416, the target may not fulfill the DAPS finalization radio conditions, and cancels the DAPS HO (e.g., release the target context/resources/configuration and communicate only with the source).

The signaling where the WTRU may send an RLF prediction report is not shown in procedure 400. If the signaling where the WTRU sends an RLF prediction report was configured and the WTRU sends the report, some of the DAPS related configuration may be sent to the WTRU as a response (e.g., the whole DAPS configuration, just indication to activate a previous DAPS configuration, and/or radio thresholds related to initiating/finalizing the DAPS, etc.).

What is claimed is:

1. A wireless transmit/receive unit (WTRU) comprising:
a processor configured to:
send, to a network, capability information related to radio link failure (RLF) prediction, wherein the capability information is based on an artificial intelligence (AI)/machine learning (ML) model;
receive, from the network, first configuration information associated with radio link monitoring (RLM) and RLF detection and prediction;
receive, from the network, second configuration information associated with a dual active protocol stack (DAPS) handover configuration to one or more candidate cells wherein the DAPS handover configuration comprises a condition to initiate a DAPS handover and a condition to cancel a DAPS handover, and wherein the processor is configured to initiate the DAPS handover upon a determination that the condition to initiate the DAPS handover has been satisfied, or to cancel the DAPS handover to a target cell upon a determination that the condition to cancel the DAPS handover has been satisfied;
predict RLF of a serving cell of the WTRU at a predicted RLF time;
determine the target cell from the one or more candidate cells;
initiate the DAPS handover with the target cell using the DAPS handover configuration corresponding with the target cell and while maintaining a connection with the serving cell;
detect a RLF of the serving cell at the predicted RLF time or within a time window that includes the predicted RLF time; and
finalize the DAPS handover to the target cell.

2. (canceled)

3. The WTRU of claim 1, wherein the condition to initiate the DAPS handover comprises a predicted RLF time and a signal level threshold, and wherein the processor is configured to initiate the DAPS handover with the target cell upon a prediction that the WTRU will experience a RLF with the serving cell within the predicted RLF time and a signal level of the target cell is above the signal level threshold.

4. The WTRU of claim 3, wherein the processor is configured to determine the target cell based on the target cell having a strongest signal level from the one or more candidate cells that have a respective signal level above the signal level threshold.

5. The WTRU of claim 1, wherein the DAPS handover configuration comprises a condition to finalize the DAPS handover, and wherein the processor is configured to finalize the DAPS handover upon a determination that the condition to finalize the DAPS handover has been satisfied.

6. The WTRU of claim 5, wherein the condition to finalize the DAPS handover is the determination that the WTRU has experienced RLF with the serving cell at the predicted RLF time or within the time window that includes the predicted RLF time.

7. The WTRU of claim 6, wherein the processor is configured to release the connection with the serving cell and send an indication to the network that the DAPS handover has been finalized and the connection with the serving cell was released.

8. (canceled)

9. The WTRU of claim 1, wherein the condition to cancel the DAPS handover is the determination that the WTRU has not experienced RLF with the serving cell at the predicted RLF time or within the time window that includes the predicted RLF time.

10. The WTRU of claim 9, wherein the processor is configured to:
release the connection with the target cell; and
send, to the network, an indication indicating that the DAPS handover has been canceled and the connection with the target cell was released.

11. A method performed by a wireless transmit/receive unit (WTRU), the method comprising:
sending, to a network, capability information related to radio link failure (RLF) prediction, wherein the capability information is based on an artificial intelligence (AI)/machine learning (ML) model;
receiving, from the network, first configuration information associated with radio link monitoring (RLM) and RLF detection and prediction;
receiving, from the network, second configuration information associated with a dual active protocol stack (DAPS) handover configuration to one or more candidate cells, wherein the DAPS handover configuration comprises a condition to initiate a DAPS handover and a condition to cancel a DAPS handover, and wherein the method comprises initiating the DAPS handover upon a determination that the condition to initiate the DAPS handover has been satisfied, or cancelling the DAPS handover to a target cell upon a determination that the condition to cancel the DAPS handover has been satisfied;
predicting RLF of a serving cell of the WTRU at a predicted RLF time;
determining the target cell from the one or more candidate cells;
initiating the DAPS handover with the target cell using the DAPS handover configuration corresponding with the target cell and while maintaining a connection with the serving cell;
detecting a RLF of the serving cell at the predicted RLF time or within a time window that includes the predicted RLF time; and
finalizing the DAPS handover to the target cell.

12. (canceled)

13. The method of claim 11, wherein the condition to initiate the DAPS handover comprises a predicted RLF time and a signal level threshold, and wherein the method further comprises initiating the DAPS handover with the target cell upon a prediction that the WTRU will experience a RLF with the serving cell within the predicted RLF time and a signal level of the target cell is above the signal level threshold.

14. The method of claim 13, wherein the method further comprises determining the target cell based on the target cell having a strongest signal level from the one or more candidate cells that have a respective signal level above the signal level threshold.

15. The method of claim 11, wherein the DAPS handover configuration comprises a condition to finalize the DAPS handover, and wherein the method further comprises finalizing the DAPS handover upon a determination that the condition to finalize the DAPS handover has been satisfied.

16. The method of claim 15, wherein the condition to finalize the DAPS handover is the determination that the WTRU has experienced RLF with the serving cell at the predicted RLF time or within the time window that includes the predicted RLF time.

17. The method of claim 16, wherein the method further comprises releasing the connection with the serving cell and sending an indication to the network that the DAPS handover has been finalized and the connection with the serving cell was released.

18. (canceled)

19. The method of claim 1118, wherein the condition to cancel the DAPS handover is the determination that the WTRU has not experienced RLF with the serving cell at the predicted RLF time or within the time window that includes the predicted RLF time.

20. The method of claim 19, wherein the method further comprises:
releasing the connection with the target cell; and
sending, to the network, an indication indicating that the DAPS handover has been canceled and the connection with the target cell was released.
